(19) United States
(12) Patent Application Publication
(10) Pub. No.: US 2020/0082966 A1
(43) Pub. Date: Mar. 12, 2020

(54) IRON-BASED MAGNETIC THIN FILMS

(71) Applicants: THE BOARD OF TRUSTEES OF THE UNIVERSITY OF ALABAMA, Tuscaloosa, AL (US); TDK CORPORATION, Shibaura, Tokyo (JP)

(72) Inventors: Takao SUZUKI, Tuscaloosa, AL (US); Tim MEWES, Northport, AL (US); Gary J. MANKEY, Tuscaloosa, AL (US); Isao KANADA, Tokyo (JP)

(21) Appl. No.: 16/305,135

(22) PCT Filed: May 30, 2017
(86) PCT No.: PCT/US2017/034935

§ 371 Date: Nov. 28, 2018

Related U.S. Application Data
(60) Provisional application No. 62/343,230, filed on May 31, 2016.

(51) Int. Cl. H01F 10/00; H01F 10/14

(52) U.S. Cl. CPC H01F 10/007; H01F 10/14

(57) ABSTRACT

An iron-based magnetic thin film comprising from 0% to 25% of aluminum in terms of atomic ratio; wherein the iron-based magnetic thin film comprises a plurality of crystals having an average crystallite size of 100 Å or less; the iron-based magnetic thin film is disposed on a surface of a substrate; and a <110> direction of a crystal of the iron-based magnetic thin film is perpendicular to the surface of the substrate.

### CROSS-REFERENCE TO RELATED APPLICATIONS

This application claims the benefit of U.S. Provisional Application No. 62/343,230, files May 31, 2016, which is hereby incorporated herein by reference in its entirety.

### FIELD

The present disclosure generally relates to soft magnetic materials used in the high-frequency range, including the gigahertz range, and in particular to an iron (Fe)-based magnetic thin film having an improved damping factor and improved coercive force.

### BACKGROUND

As the capacity and speed provided by communication technologies increase, magnetic materials used in electronic parts such as inductors, low-pass filters, and bandpass filters are increasingly required to have low magnetic loss in the high-frequency band, such as the gigahertz band.

In general, losses in soft magnetic materials can be caused by hysteresis loss, eddy current loss, and/or residual loss. Residual loss refers to loss other than hysteresis loss and eddy current loss.

Since hysteresis loss is proportional to the magnetic hysteresis area, the hysteresis loss can be decreased by decreasing the magnetic hysteresis area by decreasing coercive force.

The eddy current loss can be effectively decreased by increasing the electrical resistance of the magnetic material, or, if the magnetic material is a thin film to be magnetized in an in-plane direction, by decreasing the thickness of the thin film.

Examples of residual loss include losses caused by resonance phenomena, such as domain-wall resonance and resonance caused by rotation magnetization (ferromagnetic resonance). Domain-wall resonance can be reduced by decreasing the size of the crystals comprising the magnetic material to a single-domain critical grain size or less, to thereby eliminate domain walls. For isotropic crystals of iron, the single-domain critical grain size is about 280 angstroms (hereinafter denoted as Å).

When the linewidth of the resonance caused by rotation magnetization is narrowed, the corresponding loss can be decreased at high frequencies near the resonance frequency. In general, the resonance caused by rotation magnetization has a linewidth in a frequency dependence of permeability, and the linewidth is proportional to the damping factor a. Thus, the broadening of the resonance peak can be reduced by controlling the damping factor to a low value, and thus low loss can be achieved in a wider frequency band.

Kuanr et al. measured the ferromagnetic resonance of an iron thin film grown by molecular beam epitaxy (Kuanr B K et al. Journal of Applied Physics, 2004, 95(11), 6610-6612). As the film became thinner, the linewidth of resonance gradually increased due to external factors such as surface roughness. Kuanr et al. report that the intrinsic damping factor of the material predicted by eliminating the influence of external factors is 0.003 with respect to the linewidth of the magnetic field and 0.0043 with respect to the linewidth of the frequency.

External factors that have influence on loss are surface roughness, defects within the material, and crystal orientation. It is important to control these factors.

### SUMMARY

Described herein are magnetic materials having low loss. The magnetic materials described herein can be used to make Fe-based magnetic thin films having an improved damping factor and improved coercive force.

In some examples, the magnetic thin films can comprise an iron-based magnetic thin film that comprises from 0% to 25% (inclusive of 0%) of aluminum in terms of atomic ratio. In some examples, the iron-based magnetic thin film can comprise a plurality of crystals having an average crystallite size of 100 Å or less. In some examples, a <110> direction of a crystal contained in the material is perpendicular to a substrate surface.

Also described herein are magnetic materials that have a low damping factor and/or low coercive force and can be suitable for use in the gigahertz band.

Additional advantages of the disclosed compositions will be set forth in part in the description which follows, and in part will be obvious from the description. The advantages of the disclosed compositions will be realized and attained by means of the elements and combinations particularly pointed out in the appended claims. It is to be understood that both the foregoing general description and the following detailed description are exemplary and explanatory only and are not restrictive of the disclosed compositions, as claimed.

### DETAILED DESCRIPTION

The materials, compositions, articles, and methods described herein can be understood more readily by reference to the following detailed description of specific aspects of the disclosed subject matter and the Examples included therein.

Before the present materials, compositions, articles, devices, and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### General Definitions

In this specification and in the claims that follow, reference will be made to a number of terms, which shall be defined to have the following meanings:

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “an ionic liquid” includes mixtures of two or more such ionic liquids, reference to “the compound” includes mixtures of two or more such compounds, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed, then “less than or equal to” the value, “greater than or equal to the value,” and possible ranges between values are also disclosed, as appropriately understood by the skilled artisan. For example, if the value “10” is disclosed, then “less than or equal to 10” as well as “greater than or equal to 10” is also disclosed. It is also understood that throughout the application data are provided in a number of different formats and that this data represent endpoints and starting points and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

### Magnetic Thin Films

Described herein are Fe-based magnetic thin films. In some examples, the Fe-based magnetic thin films can comprise aluminum (Al) in an atomic ratio of 0% or more (e.g., no aluminum, 1% or more, 2% or more, 3% or more, 4% or more, 5% or more, 6% or more, 7% or more, 8% or more, 9% or more, 10% or more, 11% or more, 12% or more, 13% or more, 14% or more, 15% or more, 16% or more, 17% or more, 18% or more, 19% or more, 20% or more, 21% or more, 22% or more, 23% or more, or 24% or more). In some examples, the Fe-based magnetic thin films can comprise Al in an atomic ratio of 25% or less (e.g., 24% or less, 23% or less, 22% or less, 21% or less, 20% or less, 19% or less, 18% or less, 17% or less, 16% or less, 15% or less, 14% or less, 13% or less, 12% or less, 11% or less, 10% or less, 9% or less, 8% or less, 7% or less, 6% or less, 5% or less, 4% or less, 3% or less, 2% or less, 1% or less, or none). The atomic ratio of Al in the Fe-based magnetic thin films can range from any of the minimum values described above to any of the maximum values described above. For example, the Fe-based magnetic thin films can comprise an atomic ratio of Al of from 0% to 25%, inclusive, (e.g., from 0% to 12%, from 12% to 25%, from 0% to 5%, from 5% to 10%, from 10% to 15%, from 15% to 20%, from 20% to 25%, or from 5% to 20%).

In some examples, the Fe-based magnetic thin films can comprise a plurality of crystals having an average crystallite size. “Average crystallite size,” “mean crystallite size,” and “median crystallite size” are used interchangeably herein, and generally refer to the statistical mean crystallite size of the crystals in a population of crystals. For example, the average crystallite size for a plurality of crystals with a substantially spherical shape can comprise the average diameter of the plurality of crystals. For a crystal with a substantially spherical shape, the diameter of a crystal can refer to the largest linear distance between two points on the surface of the crystal. For an anisotropic crystal, the average crystallite size can refer to, for example, the average maximum dimension of the crystal (e.g., the length of a rod shaped crystal, the diagonal of a cube shaped crystal, the bisector of a triangular shaped crystal, etc.) Average crystallite size can be measured using methods known in the art, such as evaluation by scanning electron microscopy, transmission electron microscopy, and/or X-ray diffraction.

In some examples, the Fe-based magnetic thin films can comprise a plurality of crystals having an average crystallite size of 100 Å or less (e.g., 90 Å or less, 80 Å or less, 70 Å or less, 60 Å or less, 50 Å or less, 45 Å or less, 40 Å or less, 35 Å or less, 30 Å or less, 25 Å or less, 20 Å or less, 15 Å or less, 10 Å or less, or 5 Å or less). In some examples, the Fe-based magnetic thin films can comprise a plurality of crystals having an average crystallite size of 1 Å or more (e.g., 5 Å or more, 10 Å or more, 15 Å or more, 20 Å or more, 25 Å or more, 30 Å or more, 35 Å or more, 40 Å or more, 45 Å or more, 50 Å or more, 60 Å or more, 70 Å or more, 80 Å or more, or 90 Å or more). The average crystallite size of the plurality of crystals of the Fe-based thin films can range from any of the minimum values described above to any of the maximum values described above. For example, the Fe-based magnetic thin films can comprise a plurality of crystals having an average crystallite size of from 1 Å to 100 Å (e.g., from 1 Å to 50 Å, from 50 Å to 100 Å, from 1 Å to 20 Å, from 20 Å to 40 Å, from 40 Å to 60 Å, from 60 Å to 80 Å, from 80 Å to 100 Å, or from 10 Å to 90 Å).

The Fe-based magnetic thin films can have a thickness of from 1 Å to 1000 Å (e.g., from 1 Å to 750 Å, from 1 Å to 500 Å, from 1 Å to 250 Å, from 1 Å to 100 Å, from 100 Å to 1000 Å, from 100 Å to 750 Å, for 100 Å to 500 Å, from 100 Å to 250 Å, from 250 Å to 1000 Å, from 250 Å to 750 Å, from 250 Å to 500 Å, from 500 Å to 1000 Å, from 500 Å to 750 Å, from 750 Å to 1000 Å, or from 250 Å to 550 Å).

The Fe-based magnetic thin films can, in some examples, have a damping factor less than 0.01 (e.g., 0.0095 or less, 0.0090 or less, 0.0085 or less, 0.0080 or less, 0.0075 or less, 0.0070 or less, 0.0065 or less, 0.0060 or less, 0.0055 or less, 0.0050 or less, 0.0045 or less, 0.0040 or less, 0.0035 or less, 0.0030 or less, 0.0025 or less, 0.0020 or less, 0.0015 or less, or 0.0010 or less).

In some examples, the Fe-based magnetic thin films can have a coercive force less than 30 Oe (e.g., 29 Oe or less, 28 Oe or less, 27 Oe or less, 26 Oe or less, 25 Oe or less, 24 Oe or less, 23 Oe or less, 22 Oe or less, 21 Oe or less, 20 Oe or less, 19 Oe or less, 18 Oe or less, 17 Oe or less, 16 Oe or less, 15 Oe or less, 14 Oe or less, 13 Oe or less, 12 Oe or less, 11 Oe or less, 10 Oe or less, 9 Oe or less, 8 Oe or less, 7 Oe or less, 6 Oe or less, 5 Oe or less, 4 Oe or less, 3 Oe or less, 2 Oe or less, or 1 Oe or less).

In some examples, the <110> direction of the crystal constituting the Fe-based magnetic thin film is perpendicular to the substrate surface.

### Method for Making Magnetic Material

Also disclosed herein are methods of making the magnetic materials described herein. In some examples, the methods can comprise preparing a target material as a raw material. Single-element targets of Fe and Al can be used or one target material having a composition designed to form a thin film of an intended composition can be used. In some examples, an alloy target and a single-element target can be used in combination and sputtering can be conducted at an appropriate ratio. Since oxygen increases the coercive force of the magnetic material, in certain examples, the oxygen content in the target material is as low as possible.

The substrate on which a film is deposited by sputtering can be formed of any suitable material, for example, metals, glass, silicon, ceramics, and combinations thereof. In certain examples, the substrate is formed from a material that does not react with Fe, Al, or Fe—Al alloys.

In some examples, a vacuum chamber is used to deposit the film of magnetic material via sputtering. The vacuum chamber of a film deposition apparatus in which sputtering is to be conducted can be evacuated to 10⁻⁵ Torr or lower (e.g., 9×10⁻⁶ Torr or less, 8×10⁻⁶ Torr or less, 7×10⁻⁶ Torr or less, 6×10⁻⁶ Torr or less, 5×10⁻⁶ Torr or less, 4×10⁻⁶ Torr or less, 3×10⁻⁶ Torr or less, 2×10⁻⁶ Torr or less, 1×10⁻⁶ Torr or less, 9×10⁻⁷ Torr or less, 8×10⁻⁷ Torr or less, 7×10⁻⁷ Torr or less, 6×10⁻⁷ Torr or less, 5×10⁻⁷ Torr or less, 4×10⁻⁷ Torr or less, 3×10⁻⁷ Torr or less, 2×10⁻⁷ Torr or less, or 1×10⁻⁷ Torr or less). In some examples, the vacuum chamber can be evacuated to 10⁻⁶ Torr or lower. In some examples, the vacuum chamber can be evacuated to a pressure to remove impurity elements, such as oxygen, as much as possible.

In some examples, preliminary sputtering can be conducted to expose a clean surface of the target material prior to film deposition. In certain examples, the film deposition apparatus has a shielding mechanism, which can be manipulated in a vacuum state, between the substrate and the target. Any suitable sputtering methods can be used. In certain examples, the sputtering method can be a magnetron sputtering method. Any gas which does not react with the magnetic material can be used as the atmosphere gas during the deposition, for example, argon gas (Ar). The sputtering power supply can be a DC or RF power supply, and can be appropriately selected according to the target material.

A film can be deposited by using the target materials and the substrate described above. Examples of the film deposition method include a co-sputtering method, wherein a plurality of targets are used simultaneously to deposit individual components at the same time, and a multilayer film method, wherein multiple targets are used one at a time in conducting deposition.

In certain examples, when a film is to be deposited by a multilayer film method, Fe layers and Al layers can be alternately deposited. When the substrate comprises an oxide of an element that has a higher standard free energy of formation of oxide than Al, for example SiO₂ glass, an Fe film is preferably formed first in order to minimize or prevent oxidation of Al. When the substrate comprises an oxide of an element that has a higher standard free energy of formation of oxide than Fe, the reactivity to a sample must be confirmed before use.

The thickness of the Fe-based magnetic thin film can be set to a desired thickness by adjusting the film deposition speed, time, argon atmosphere pressure, and, if the multilayer film method is employed, the number of times deposition is conducted, or a combination thereof. In order to adjust the thickness, the relationship between the film deposition conditions and the thickness can be studied in advance. The thickness can be measured by methods known in the art, for example contact profilometry, X-ray reflectometry, or polarized-light microscopy (ellipsometry).

During sputtering, the substrate can, in some examples, be heated. In the absence of heating, an alloy thin film can be obtained using the multilayer film method by depositing each of the Fe and Al layers to a thickness of 50 Å or less (e.g., 45 Å or less, 40 Å or less, 35 Å or less, 30 Å or less, 25 Å or less, 20 Å or less, 15 Å or less, 10 Å or less, or 5 Å or less) where possible. In some examples, low-temperature heating can be conducted to remove strain after film deposition. If the substrate is to be heated, heating can be conducted in an inert gas atmosphere, such as argon, or in vacuum so as to minimize or prevent oxidation of the sample as much as possible.

In some examples, a protective film can be formed on top of the Fe-based magnetic thin film to minimize or prevent oxidation of the magnetic thin film. The protective film can be disposed on the Fe-based magnetic thin film. The protective film can, for example, be formed of Mo, W, Ru, Ta, or the like, or combinations thereof.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention, which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures and other reaction ranges and conditions that can be used to optimize the product purity and yield obtained from the described process. Only reasonable and routine experimentation will be required to optimize such process conditions.

An Fe single-element target and an Al single-element target were used as the target materials. A Si substrate, namely, a Si(100) substrate, having a (100) surface and a SiO₂ glass substrate were used as the substrate on which the deposition was to be conducted.

An apparatus equipped with a plurality of sputtering mechanisms in the same chamber and allowing evacuation up to 10⁻⁷ Torr was used as the film deposition apparatus. The target materials mentioned above and a tungsten (W) target material for forming a protective film were loaded into the film deposition apparatus. Sputtering was conducted by a magnetron sputtering method in a 4 mTorr argon atmosphere. The power supplied to sputtering guns and the film deposition time were adjusted according to the intended film composition.

Preparation of Samples

An Fe single-layer film formed on a Si(100) substrate without any protective layer was prepared as an Fe-based magnetic thin film (Fe thin film) of Example 1.

Fe-based magnetic thin films of Examples 2 to 12 were prepared as follows. First, an Fe layer was formed on a substrate, and then an Al layer. During this process, the thickness of the Fe layer was fixed to 19 Å. In order to change the Al content of the Fe-based magnetic thin film, the thickness of the Al layer was varied in the range of 0 to 7 Å depending on the desired Al content. Lastly, a W layer having a thickness of 5 Å was deposited as a protective layer in Examples 2 to 7. Å Ru layer having a thickness of 50 Å was deposited as a protective layer in Examples 8 to 12. In Examples 2, 4, and 6, a Si(100) substrate was used. In Examples 3, 5, and 7, a SiO₂ glass substrate was used. In Examples 8 to 12, a MgO(100) substrate was used. No heat treatment was conducted during or after deposition.

Evaluation of Structure

The thickness of the film of each sample for Examples 1-12 was determined by X-ray reflectometry. X-ray diffractometry was conducted to measure the diffraction pattern in the 20 range of 25° to 90°, and the diffraction peak position of each sample was determined by a half-value-width midpoint method. The generated phase was identified from the obtained peak position, and then the lattice constant was determined. The half-value width of the diffraction peak of each sample was used to calculate the crystallite size from the Scherrer equation. The results are summarized in Table 1.

TABLE 1
Summary of sample properties for Examples 1-12.

| | Al | | Thickness | Peak position | Lattice constant | Crystallite size × |
|---|---|---|---|---|---|---|
| | (at %) | Substrate | (Å) | 2θ (degree) | (Å) | 10² (Å) |
| Example 1 | 0 | Si (100) | 290 | 44.67 | 2.87 | 1 |
| Example 2 | 5 | Si (100) | 443 | 44.47 | 2.88 | 1 |
| Example 3 | 5 | SiO₂ glass | 438 | 44.38 | 2.89 | 1 |
| Example 4 | 10 | Si (100) | 421 | 44.32 | 2.89 | 0.9 |
| Example 5 | 10 | SiO₂ glass | 435 | 44.13 | 2.90 | 1 |
| Example 6 | 21 | Si (100) | 504 | 43.99 | 2.91 | 0.8 |
| Example 7 | 21 | SiO₂ glass | 497 | 43.83 | 2.92 | 1 |
| Example 8 | 0 | MgO(100) | 482 | — | — | — |
| Example 9 | 2 | MgO(100) | 429 | — | — | — |
| Example 10 | 5 | MgO(100) | 452 | — | — | — |
| Example 11 | 10 | MgO(100) | 450 | — | — | — |
| Example 12 | 20 | MgO(100) | 503 | — | — | — |

The thickness of the film was 290 Å in Example 1, and ranged from 421 Å to 504 Å in the other examples (e.g., Examples 2 to 12).

The X-ray diffraction pattern of every example measured within the 20 range of 25° to 90° had only one diffraction peak from the Fe- or Fe-Al-based magnetic thin film. This diffraction peak was at around 44°. The peak position of Example 1 is 44.67° and matches that of Fe(110). In Examples 2 to 7, the peak position around 44° has a tendency to shift toward the low angle side with the increase in Al content. The lattice constant determined from the peak position has a tendency to increase with the increase in Al content. The crystallite size was about 100 Å in all examples.

These results indicate that in Examples 2 to 7, Fe and Al formed a solid solution, that fine crystals about 100 Å in size were formed in all examples, and that the <110> direction of these crystals is perpendicular to the substrate surface. In Examples 8 to 12, the (100) peak overlaps the MgO(200) peak and thus was not identifiable. However, Examples 8 to 12 likely have similar orientation and crystal grain size to those of Examples 1 to 7.

Evaluation of Magnetic Properties

The hysteresis loop of the each sample for Examples 1-12 was measured with a vibrating sample magnetometer (VSM) to determine the coercive force at room temperature. The ferromagnetic resonance (FMR) within the plane of the thin film was measured in the frequency range of 12 to 68 GHz and a DC magnetic field intensity range of 0 to 16.5 kOe. The linewidth at each frequency was determined from the measurement results. The relationship between the resonance frequency and the linewidth was determined by linear least squares data fitting and the damping factor a was determined. The results are summarized in Table 2.

TABLE 2
Summary of sample magnetic properties for Examples 1-12.

| | Al (at %) | Substrate | Hc (Oe) | α |
|---|---|---|---|---|
| Example 1 | 0 | Si (100) | 27 | 0.0029 |
| Example 2 | 5 | Si (100) | 10 | 0.0020 |
| Example 3 | 5 | SiO₂ glass | 8 | 0.0062 |
| Example 4 | 10 | Si (100) | 27 | 0.0087 |
| Example 5 | 10 | SiO₂ glass | 28 | 0.0056 |
| Example 6 | 21 | Si (100) | 10 | 0.0067 |
| Example 7 | 21 | SiO₂ glass | 9 | 0.0058 |
| Example 8 | 0 | MgO (100) | 21 | |
| Example 9 | 2 | MgO (100) | 3 | 0.0038 |
| Example 10 | 5 | MgO (100) | 3 | 0.0039 |
| Example 11 | 10 | MgO (100) | 7 | 0.0035 |
| Example 12 | 20 | MgO (100) | 8 | 0.0065 |

A coercive force of less than 30 Oe was observed in all Examples. In particular, a coercive force as low as about 10 Oe was observed in Examples 2, 3, 6, and 7 in which the Al content was 5 at % or 21 at %. In Examples 9 and 10 in which the Al content was 2% and 5% and MgO(100) was used as the substrate, and a particularly low coercive force of 3 Oe, was obtained. This is can be because the spacing of MgO(100) that appears on the MgO(100) face is close to the spacing of the Fe(100) and good lattice matching can therefore be achieved.

In Example 1, an excellent damping factor was obtained (α=0.0029), since it was lower than the values that were determined by excluding the structural external factors of the Fe thin films (e.g., 0.003 and 0.0043) described by Kuanr et al in the aforementioned non-patent document (Kuanr B K et al. Journal of Applied Physics, 2004, 95(11), 6610-6612). In Examples 2 to 7, the damping factor was also low, i.e., less than 0.009.

All of the Fe-based magnetic thin films of Examples had an average crystallite size equal to or lower than the single-domain critical grain size of the sample, and the <110> direction of the crystal was perpendicular to the substrate surface in all Examples. These compositional and structural features can be attributable to the decrease in damping factor and coercive force.

The methods and compositions of the appended claims are not limited in scope by the specific methods and compositions described herein, which are intended as illustrations of a few aspects of the claims and any methods and compositions that are functionally equivalent are within the scope of this disclosure. Various modifications of the methods and compositions in addition to those shown and described herein are intended to fall within the scope of the appended claims. Further, while only certain representative methods, compositions, and aspects of these methods and compositions are specifically described, other methods and compositions and combinations of various features of the methods and compositions are intended to fall within the scope of the appended claims, even if not specifically recited. Thus a combination of steps, elements, components, or constituents can be explicitly mentioned herein; however, all other combinations of steps, elements, components, and constituents are included, even though not explicitly state

1. An iron-based magnetic thin film comprising:
from 0% to 25% of aluminum in terms of atomic ratio;
wherein
the iron-based magnetic thin film comprises a plurality of crystals having an average crystallite size of 100 Å or less;
the iron-based magnetic thin film is disposed on a surface of a substrate; and
a <110> direction of a crystal of the iron-based magnetic thin film is perpendicular to the surface of the substrate.

2. The iron-based magnetic thin film of claim 1, wherein the film has a thickness of from 1 Å to 1000 Å.

3. The iron-based magnetic thin film of claim 1, wherein the film has a thickness of form 250 Å to 550 Å.

4. The iron-based magnetic thin film of claim 1, wherein the film has a damping factor of 0.01 or less.

5. The iron-based magnetic thin film of claim 1, wherein the film has a damping factor of 0.005 or less.

6. The iron based magnetic thin film of claim 1, wherein the film has a damping factor of 0.003 or less.

7. The iron-based magnetic thin film of claim 1, wherein the film has a coercive force of 30 Oe or less.

8. The iron-based magnetic thin film of claim 1, wherein the film has a coercive force of 10 Oe or less.

9. The iron-based magnetic thin film of claim 1, wherein the film is formed from a plurality of layers, each layer comprising Fe, Al, or a combination thereof.

10. The iron-based magnetic thin film of claim 9, wherein each layer has a thickness of 50 Å or less.

11. The iron-based magnetic thin film of claim 1, wherein the substrate comprises a metal, glass, silicon, a ceramic, or a combination thereof.

12. The iron-based magnetic thin film of claim 1, further comprising a protective film disposed on the iron-based magnetic thin film.

13. The iron-based magnetic thin film of claim 12, wherein the protective film comprises Mo, W, Ru, Ta, or a combination thereof.
